(19) United States
(12) Patent Application Publication
(10) Pub. No.: US 2012/0237024 A1
(43) Pub. Date: Sep. 20, 2012

(54) Security System Using Physical Key for Cryptographic Processes

(76) Inventors: Wei-Ti Liu, Saratoga, CA (US); Adam Chen, Cupertino, CA (US); Kevin Wayne Do, Sunnyvale, CA (US); Reid Augustin, Menlo Park, CA (US)

(21) Appl. No.: 13/051,829

(22) Filed: Mar. 18, 2011

(51) Int. Cl. H04L 9/18; H04L 9/00

(52) U.S. Cl. 380/44; 380/277

(57) ABSTRACT

One embodiment of the invention is based on the recognition that by keeping the encryption key (DEK) in a key device, and using the key device to perform all encryption and decryption, where the DEK is not supplied to the computing system, the above noted security problems can be overcome. The encrypted information is stored in the computing system and not in the key device. However, without the key device, it is not possible to access the encrypted information stored in the computing system. Thus, the function of the key device is similar to that of a physical key used in daily life for unlocking a door or drawer, except that the user gains access to protected information instead of access to a building, drawer or car.

### BACKGROUND OF THE INVENTION

Encryption is the process of transforming information (referred to as plaintext) using an algorithm (called cipher) to make it unreadable to anyone except those possessing special knowledge, usually referred to as a data encryption key (DEK).

Encryption has long been associated with computers. Indeed, many early advances in computer technology were driven by war time efforts to encrypt and decrypt information. The guiding principle behind modern encryption is that the encryption method (algorithm) may be public knowledge. What makes the encryption secure is the existence of a key that is known only to the entities who encrypt or who are allowed to decrypt the encrypted information. The key must be guarded and held secret in order to protect the encrypted information—if an attacker learns the key, he can decrypt the information. For example, AES 128 encryption requires a digital key 128 bits long, and AES256 requires a key of 256 bits. If the key is known for a particular block of encrypted information, then the data can be decrypted.

Modern computer systems use a variety of encryption methods to secure the information stored on them, including methods that derive a key from a password supplied by the user. These methods all have a significant drawback: the program that is performing the encryption and decryption operate inside the computer environment. This means that the encryption logic, along with the encryption keys, are all stored in the computer RAM. Any method that can read that RAM can copy the encryption key, allowing an attacker to decrypt the protected information.

Under current common operating systems, access to read the key from the RAM might require “root” or “administrator” privileges. Such privileges may or may not require a password, which may or may not be the same password required to create the key. Thus, the security of the encrypted information is jeopardized unless all parts of the overall system security are tightly maintained.

Even worse, the key exists in RAM even after the computer's power is turned off. The RAM data decays slowly (over seconds or minutes) which allows an attacker an easy way to get a copy of the key: he simply powers off the computer, and then quickly boots his own program (from a USB key or a CDROM, for example) which scans and makes a copy of the memory as it was before the power-down. Once he has this copy (which takes only a few seconds), the attacker can analyze the entire RAM image at his leisure looking for potential keys. This is known as a “cold boot” attack.

Another possible attack is known as a “key logger”. Malicious software might be installed (e.g. from a virus) on a computer system to record all keystrokes entered on the keyboard. Passwords entered to unlock an encryption scheme are recorded along with everything else the user types. The logged key-strokes are subsequently sent to the attacker who then has the necessary password to bypass the security.

A low-tech version of a key-logger attack is someone looking over the shoulder of the user as he types his password. A slightly higher tech version involves using a video camera, possibly with mirrors for a bit of obfuscation, to record the typist's every move. It is also possible to analyze the low-level electronic noise that most keyboards and computers emit to learn what keys are being typed.

### Encrypted External Drives

Encrypted external drives like USB flash keys do not store their encryption keys on the computer. All cryptographic functions are performed by the external device. Because of this, encrypted external drives offer more security than software encryption.

For an example of such approach, see US 2006/0242151 and US 2006/0239449.

Unfortunately, the user loses their data should the drive be lost or broken. Backups of the data are usually stored in the clear. Furthermore, after moving a private file to the encrypted drive, traces of the unencrypted file still remain on the originating computer.

Since data is stored on the external drive, space is limited by what the drive can hold. Upgrades are an additional cost. Encrypted drives usually employ password protection. Passwords are vulnerable to key-loggers, spy-ware, trojans, and hackers. A password may be compromised without the user's knowledge.

### Key Stored on USB Devices

USB key devices have been proposed. These devices do not perform the encryption in the USB key. Instead, a factory-programmed DEK or user supplied DEK is stored on the USB key. This DEK is given to software when the key is plugged in. Software uses the DEK to perform the encryption and decryption. For an example of such approach, see US 2004/0250087A1.

Since the DEK is located in the computer during decryption, it is still vulnerable to attacks that compromise the computer system.

### SUMMARY

The need for data protection is not limited to personal computers, but applies to many other computing systems such as cellular phones, iPads, game controllers, digital picture frames, personal digital assistants and other portable intelligent devices with data stored therein. As described herein below, computing systems include all such devices.

One embodiment of the invention is based on the recognition that by keeping the encryption key (DEK) in a key device, and using the key device to perform all encryption and decryption, where the DEK is not supplied to the computing system, the above noted security problems can be overcome. The encrypted information is stored in the computing system and not in the key device. However, without the key device, it is not possible to access the encrypted information stored in the computing system.

Thus, the function of the key device is similar to that of a physical key used in daily life for unlocking a door or drawer, except that the user gains access to protected information instead of access to a building, drawer or car.

One embodiment of the invention is directed to a device for cryptographic process, such as a key device. The device comprises a cipher engine that encrypts or decrypts data from a host computing system, a storage for storing cipher keys (DEK) used in encryption and/or decryption of the data from the host, and a controller that manages interactions of the cipher engine and the storage with the host. The device does not store therein the data that is encrypted or decrypted by the cipher engine, but sends the encrypted or decrypted data to the host computing system.

Software is installed in computer systems to work with the key device described above, to send data to the key device for encryption or decryption, so that the encrypted or decrypted data from the key device may be stored in computer systems. Such computing systems do not perform the encryption and/or decryption of the data which is performed exclusively by the key device. In this manner, the above described problems such as “cold boot” attack or key logger can be avoided. To store the encrypted data, a file is created in a memory of the computer system, as described below.

Thus, an embodiment of another aspect of the invention is directed to a host computing system having a memory and an operating system. The computing system executes a computer program to create in the system a file that behaves like a disk drive to the operating system of the system for storing encrypted information sent to it by a key device that is connected to the system and that performs cryptographic processes, and to translate accesses to this file by the system into commands, wherein when a command to read or write is issued by the computing system to the file, the computer program when executed by the computing system will cause a cipher engine in the key device to perform encryption and/or decryption of data from such file and/or to be stored into such file.

It is preferable to supply the user with both the key device and the computer program described above, so that the user can load the computer program into a computing system, and so that the above described cryptographic processes can be carried out for information protection. Thus, another embodiment of the invention is directed to supplying both the key device and the computer program described above. In one implementation of this embodiment, the computer program is supplied on a computer readable medium, such as a magnetic disk, magnetic tape, optical disk, flash memory or other types of non-volatile memory. In another implementation of this embodiment, the computer program may be downloaded from the world wide web through the internet, such as by using a link to a website where the link and instructions for the download are supplied on a storage medium such as an instruction manual or one of the above referenced computer readable media.

Yet another embodiment of the invention is directed to a computer readable medium storing a computer program for use in a computing system having a memory and an operating system, wherein when the computer program is executed by the computing system, a file that behaves like a disk drive to the operating system of the system is created in the memory of the system for storing encrypted information sent to it by a key device that is connected to the system and that performs cryptographic processes, and wherein accesses to this file by the system are translated into commands, so that when a command to read or write is issued by the system to the file, the computer program when executed by the system will cause a cipher engine in the key device to perform encryption and/or decryption of data from such file and/or to be stored into such file.

All patents, patent applications, articles, books, specifications, standards, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a block diagram of a computing system, a storage medium storing a computer program and a key device to illustrate an embodiment of the invention.

FIG. 2 is a block diagram of the key device of FIG. 1.

FIG. 3 is a flow diagram illustrating the software components of the computer program of FIG. 1 in communication with the key device of FIG. 1.

FIG. 4 is a flow chart illustrating an operation of the computing system executing the computer program of FIG. 1 in connection with the key device of FIG. 1 to create a disk encryption key (DEK) in the key device and a file-based-drive in the computing system.

FIG. 5 is a flow chart illustrating an operation of the computing system executing the computer program of FIG. 1 to create a DEK.

FIG. 6 is a flow chart illustrating an operation of the computing system executing the computer program of FIG. 1 to create a file based-drive in the computing system for storing encrypted information.

FIGS. 7 and 8 are flow charts illustrating write and read operations of the computing system executing the computer program of FIG. 1.

FIG. 9 is a flow chart illustrating how the computing system recognizes a key device and allows the key device to operate when connected to the computing system without having to re-boot the computing system.

FIGS. 10 and 11 are computer screen shots illustrating the effects when the key device is connected with and disconnected from the computing system.

FIGS. 12 and 13 are computer screen shots illustrating the secure move, delete and copy features.

FIG. 14 is a computer screen shot illustrating password entry.

FIG. 15 is a computer screen shot illustrating the process for creating a new key device and a duplicate key device.

FIG. 16 is a schematic view illustrating the creation of slave key devices from a master key.

FIGS. 17 and 18 are schematic views illustrating the encryption and decryption of DEK using a password.

Identical components in this application are labeled by the same numerals.

### DETAILED DESCRIPTION OF EXEMPLARY EMBODIMENTS

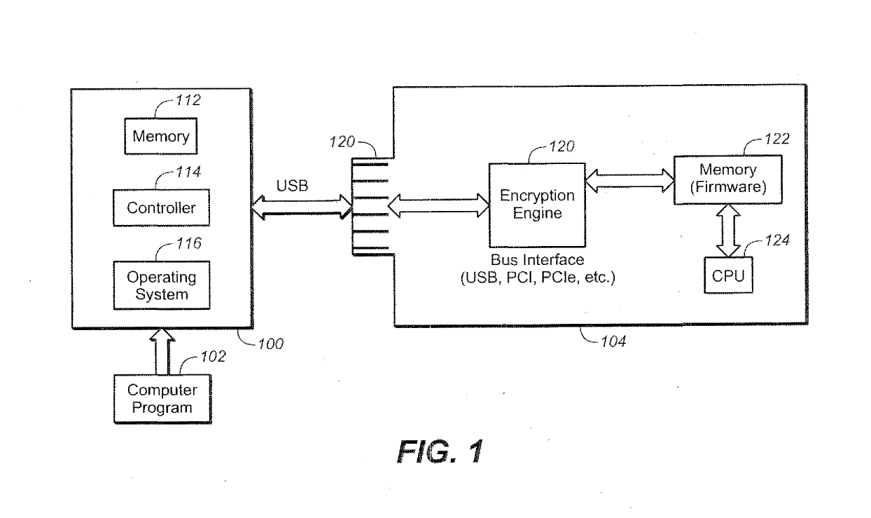

FIG. 1 is a block diagram of a computing system 100, a storage medium 102 storing a computer program and a key device 104 to illustrate an embodiment of the invention. Computing system 100 includes a memory 112, a controller 114 such as a processor and operating system 116. The computer program in medium 102 is supplied to computing system 100, which creates a file for storing encrypted data from key device 104. From the point of view of the operating system 116, this file is a drive. For this reason, this file is also referred to as a file-based drive herein. When this file is shown on a graphical display, such as a computer screen, it appears as a logical drive. When data is stored in this file, the data is said to be stored in a partition of computing system 100. Thus, the term file, file-based drive and partition are used interchangeably herein.

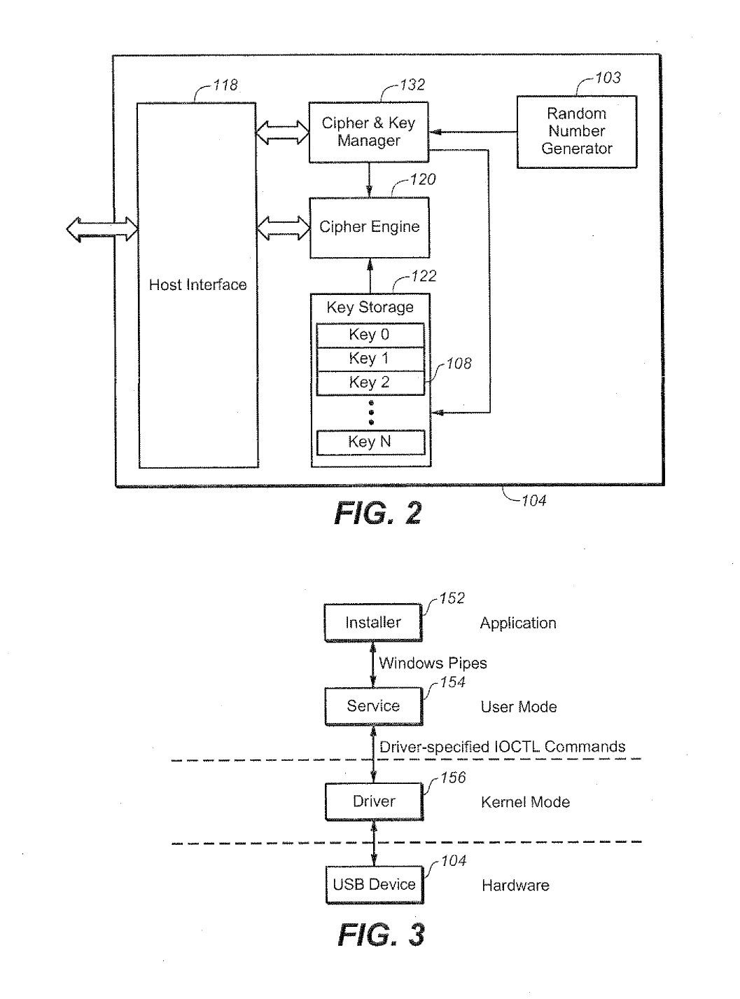

After the computer program in medium 102 is downloaded to computing system 100, it is executed by controller 114 to perform the functions of the system 100 in the manner described below. The computing system creates the file-based drive for storing encrypted data from the key device 104. The computing system 100 may then send data to the key device for encryption. After the data has been encrypted by the key device, the key device does not store the encrypted data in itself, but sends it back to the computing system 100, which then stores it in the file-based drive that has been created. To decrypt the encrypted data in the file-based drive, the computing system 100 sends such data to the key device 104. After the encrypted data has been decrypted by the key device, the key device sends it back to the computing system 100. Preferably the key device 104 has a USB interface 118 (FIG. 2) that connects to system 100 through connector 120. Interfaces other than USB may also be used, such as RFID, Smart Card, PCIe, and other interfaces.

Key device 104 also includes an encryption or cipher engine 120, a memory 122 and controller 124 which preferably is a central processoring unit (CPU). When unencrypted data is sent by system 100 to device 104, the engine 120 encrypts the data using a key (DEK) stored in memory 122 under the control of CPU 124, and the encrypted data is returned to system 100, again under the control of CPU 124. Similarly, for decrypting encrypted data which is sent to device 104 by system 100, engine 120 decrypts the data using a key (DEK) stored in memory 122 under the control of CPU 124, and the decrypted data is returned to system 100, under the control of CPU 124.

Ways other than a storage medium 102 storing a computer program may be used for loading the computer program for creating the file-based drive, such as where the computer program is downloaded from a website using a link, where the link and instructions for the download are supplied on a storage medium such as an instruction manual or a computer readable media. The instructions for the download may also be supplied through the website.

FIG. 2 is a block diagram of the key device 104 of FIG. 1. Key device 104 includes a host USB interface 118 connected to a host computing system 100. Data and information related to keys is relayed through interface 118 between the system 100 on one hand and engine 120 and cipher and key manager 132 on the other. The cipher and key manager 132 may be one of the processes or applications carried out by the CPU (in the hardware) 124 of FIG. 1.

FIG. 3 is a flow diagram illustrating the software components of the computer program in medium 102 of FIG. 1 in communication with the key device of FIG. 1. The computer program includes an installer 152, a service 154 and a driver 156 for interacting with the key device 104. The installer 152 initializes the key device 104 and creates a file in the directory of the computing system. Service 154 makes this file look and act like a disk drive to the operating system 116. Driver 156 intercepts all accesses to and from the key device 104 and translates them to commands for the key device 104, instructing it to encrypt or decrypt the data. The integration of these three parts creates a seamless experience for the user. The user accesses the encrypted partition/drive (which is just a file). These accesses are intercepted by service 154 and driver 156 and sent to the key device 104 for encryption or decryption.

In addition, the computer program in medium 102 includes a shell extension for the secure move, secure cut and paste, and secure delete functions described below. A password application in the program described below asks the user for his or her password (if enabled) whenever the key device 104 is plugged in to system 100. Manager application (running on host computer) 132 (FIG. 2) is used to manage the size and number of encrypted partitions, password modification, and device duplication.

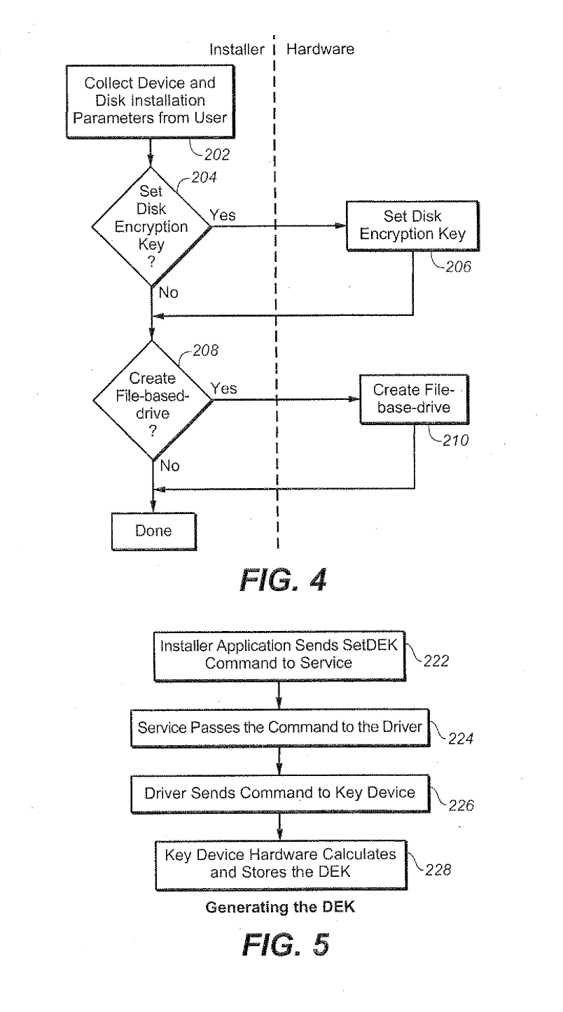

FIG. 4 is a flow chart illustrating an operation of the computing system executing the computer program of FIGS. 1 and 3 in connection with the key device of FIG. 1 to create a disk encryption key (DEK) in the key device and a file-based-drive in the computing system. In block 202, installer 152 asks for and collects, from the user of system 100, device and disk installation parameters such as options regarding the DEK (e.g. whether a key recovery phrase will be used, options regarding duplicate and master keys, non-recovery keys, passwords for key generation and so on), and the file-based-drive (e.g. size of partition). The user is then queried as to whether a DEK is to be created (diamond 204). If the answer is yes, then the installer sends command to device 104 to generate a DEK (block 206). The process of file creation will be described below. After the file or file-based-drive is created, the installer is so notified by device 104. The user is then queried as to whether a file-based-drive in the computing system is to be created (diamond 208). If the answer is yes, then the installer 152, a service 154 and a driver 156 will cooperate with device 104 to create a file or file-based-drive visible or recognizable by the operating system 116 as described below (block 210). The key device 104 and system 100 are then ready to perform data protection through cryptographic processes.

FIG. 5 is a flow chart illustrating an operation of the computing system executing the computer program of FIG. 1 to create a DEK. After the user indicates that a DEK is to be created from diamond 204, the installer sends a DEK command to the service (block 222) which passes it to the driver (block 224). The driver passes the set DEK command to the device (block 226). The device 104 creates the DEK under the control of manager 132 in CPU 124 (block 228). The DEK is stored in the device 104 and remains in device 104 and not sent to the system 100 to perform cryptographic processes.

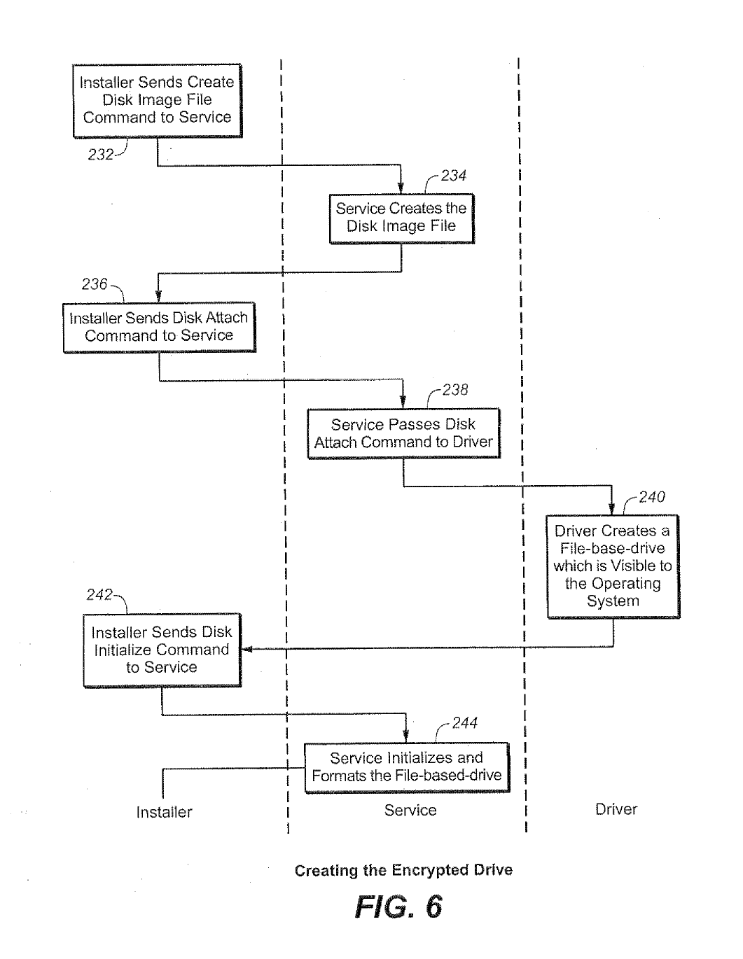

FIG. 6 is a flow chart illustrating an operation of the computing system 100 executing the computer program in medium 102 of FIG. 1 to create a file based-drive in the computing system for storing encrypted information. After the user indicates that a file-based-drive in the computing system is to be created from diamond 208, the installer sends a Create Disk Image File Command to the service (block 232). The service creates a disk image blank file (block 234) with a file identifier from the device 104, noting the file name and directory pathway. The service notifies the installer after the file has been created, and the installer then sends a Disk Attach Command to service 154 (block 236). Service 154 passes this command to driver 156 (block 238), which creates from the disk image blank file a file-based drive (block 240), so that to the operating system, this file appears to be a logical drive, where logical block addresses (“LBA”) in the file system of the operating system 116 are mapped on a one-to-one basis to offsets in this file-based drive, or file, which has the file name and pathway in the operating system directory. The operating system is now able to access the file so created. The installer then sends Disk Initialize Command to the service (block 242), which initializes and formats the file-based drive, or file (block 244). This file-based drive, or file, is the partition for storing encrypted data.

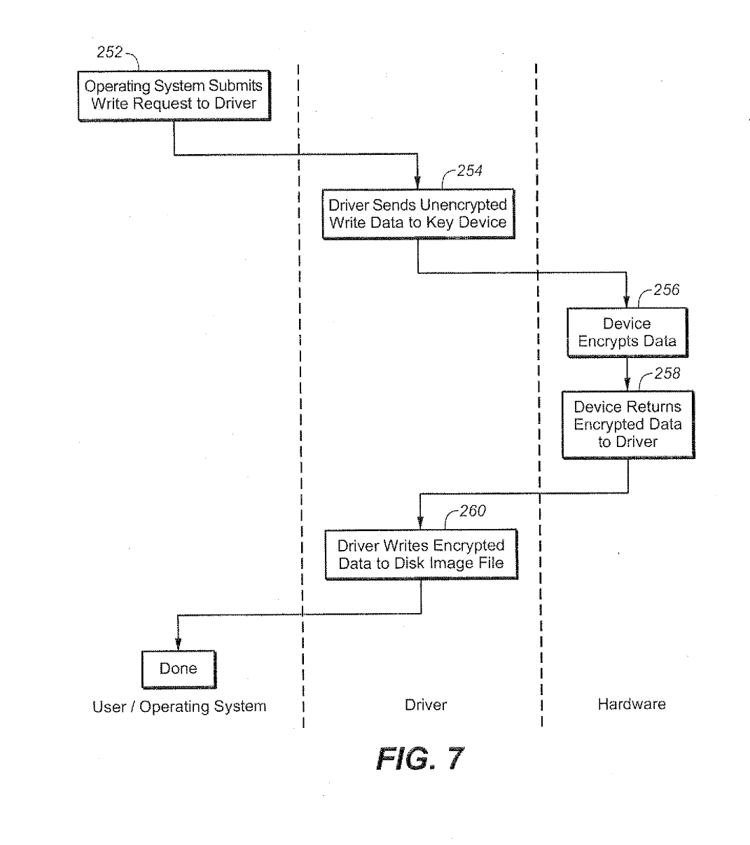

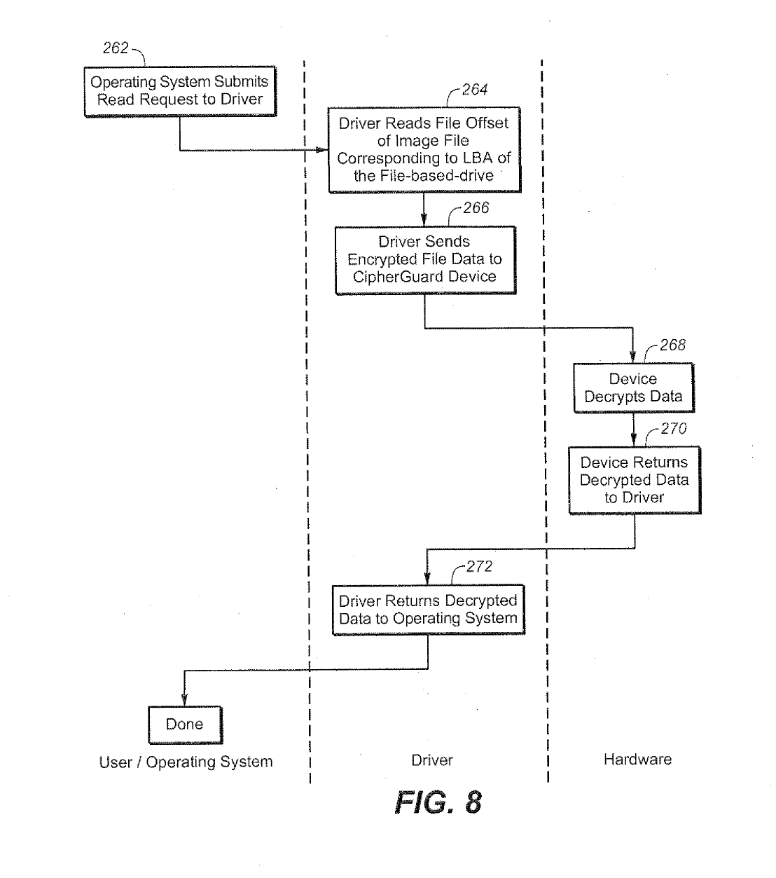

FIGS. 7 and 8 are flow charts illustrating write and read operations of the computing system executing the computer program of FIG. 1. As shown in FIG. 7, to encrypt data, the operating system submits data to be encrypted and a write command for writing the encrypted data to certain LBA to the driver 156 (block 252), which locates the file-based drive using the file name and pathway in the operating system directory, ascertains the offset of file-based file corresponding to the LBA of the write command, and sends the command and data to the key device 104 (block 254). Device 104 encrypts the data from the computing system 100 under the control of manager 132 in CPU 124 (block 256) and returns the encrypted data to driver 156 (block 258). Manager 132 selects a key from memory 122, causes the selected key to be sent from the memory to engine 120, which performs the encryption of the data from the operating system using the selected key. The driver then writes the encrypted data to the file-based-drive it located at the offset address corresponding to the LBA of the write command (block 260).

For decrypting encrypted data, as shown in FIG. 8, the operating system submits a read command for reading data from certain LBA to the driver 156 (block 262), which ascertains the offset of the file-based file corresponding to the LBA of the read command, and sends the command to the key device 104 along with the encrypted data located at the offset address corresponding to the LBA of the read command (blocks 264, 266). Device 104 decrypts the data from the computing system 100 using a key in memory 122 selected by manager 132 (block 268) and returns (block 270) the decrypted data to the driver which in turn returns it to the operating system (block 272).

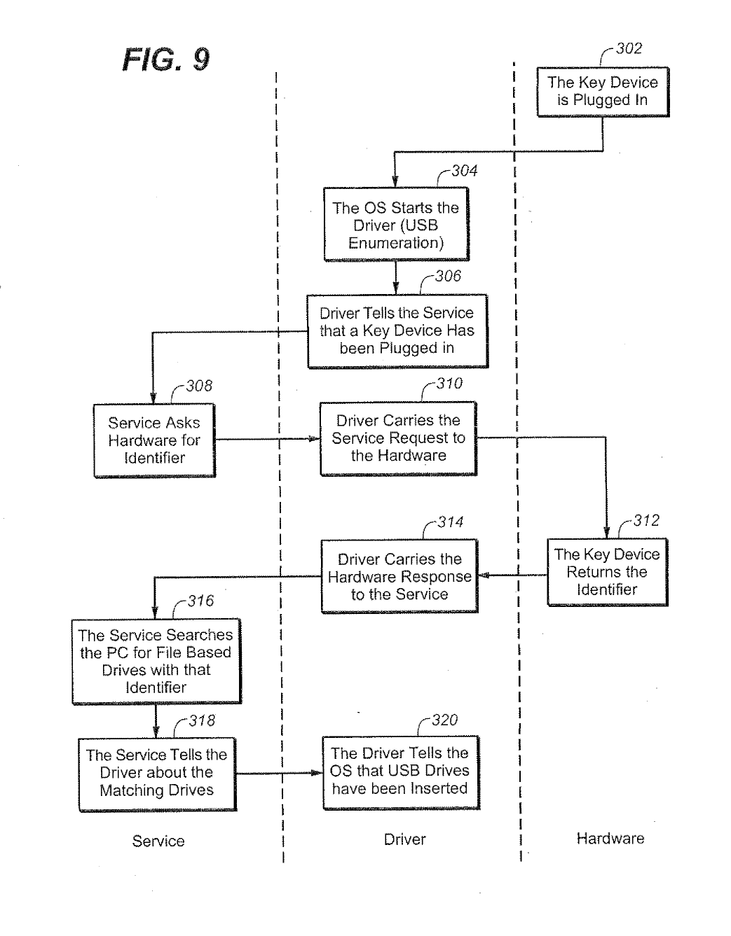

The computer program in medium 102 in FIG. 1 also enables the controller or CPU 124 of the key device to manage interactions of the cipher engine 120 and the storage 122 with the host the computing system 100 as soon as the device is connected to system 100 without the system 100 having to re-boot. This is illustrated in the flow chart FIG. 9.

When the key device is plugged in (block 302), the operating system 116 starts the driver 156 (USB enumeration) (block 304). The driver tells the service that a key device has been plugged in (block 306). The service queries the device 104 for identifier (block 308). This request is transmitted by the driver to the device 104 (block 310). The identifier is returned by the device 104 (block 312), which identifier is carried or transmitted by the driver to the service (314). The service searches the memory 112 in the system 100 for a file-based-drive with such identifier (block 318). When the identifier matches one in memory 112, the service informs the driver and the driver in turn informs the operating system 116 that a USB drive has been plugged or inserted to the system 100 (block 320), even though the device 104 is not a USB mass storage device. The operating system 116 will then automatically read from the device 104 and display the drive on a display or any other kind of graphic user interface for interaction with users. This allows the user to use the key device for cryptographic processes without having to re-boot system 100 as soon as device 104 is connected to system 100.

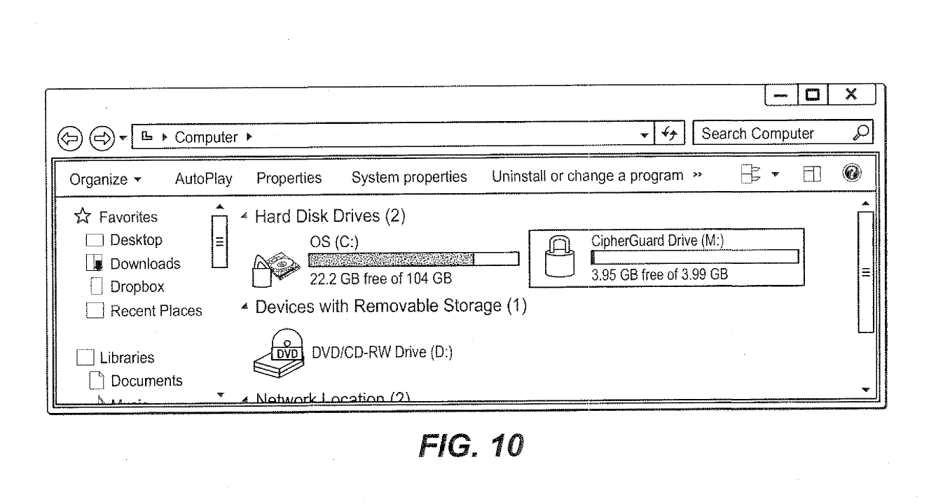

When device 104 is disconnected from system 100, this is detected by driver 156, which informs the operating system 116, which will then remove the drive from the display or any other kind of graphic user interface. These features are illustrated in FIGS. 10 and 11, which are computer screen shots. As shown in FIG. 10, the display screen of system 100 displays a drive “CipherGuard Drive” when device 104 is connected to system 100. But once device 104 is disconnected from system 100, this drive disappears, as illustrated in FIG. 11. Once the device 104 is disconnected from system 100, the data in the file-based drive in system 100 is no longer accessible to users, since system 100 does not have access to the DEK.

The computer program in medium 102 includes a shell extension for the secure move, secure cut and paste, and secure delete functions described below. Secure move, paste, and delete is a shell extension to Windows. They can be invoked only when the key device 104 is connected to the system 100.

When the user selects one of these options (Secure move, paste, and delete), system 100 will complete the requested transfer (move or paste), and then the program in medium 102 as executed by controller 114 will cause the operating system 116 to automatically overwrite the original file with garbage data. After this is done, the program in medium 102 as executed by controller 114 will request the operating system 116 to delete the data that is in the original file in a manner that the deleted data does not end up in the Recycle Bin.

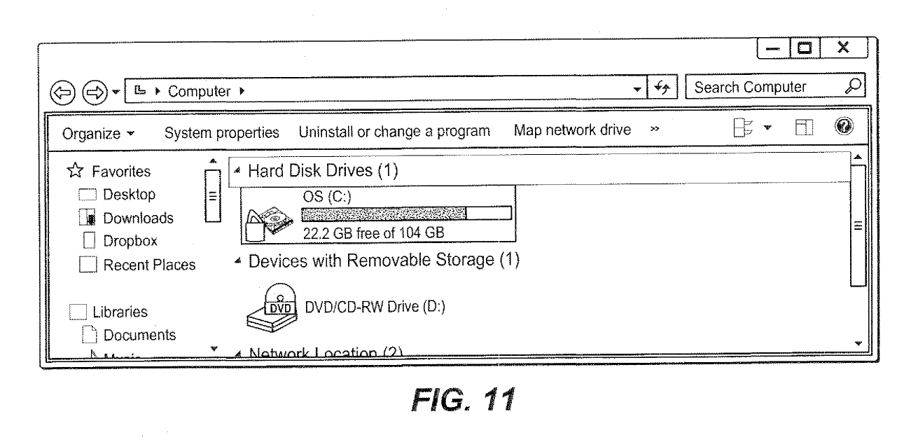

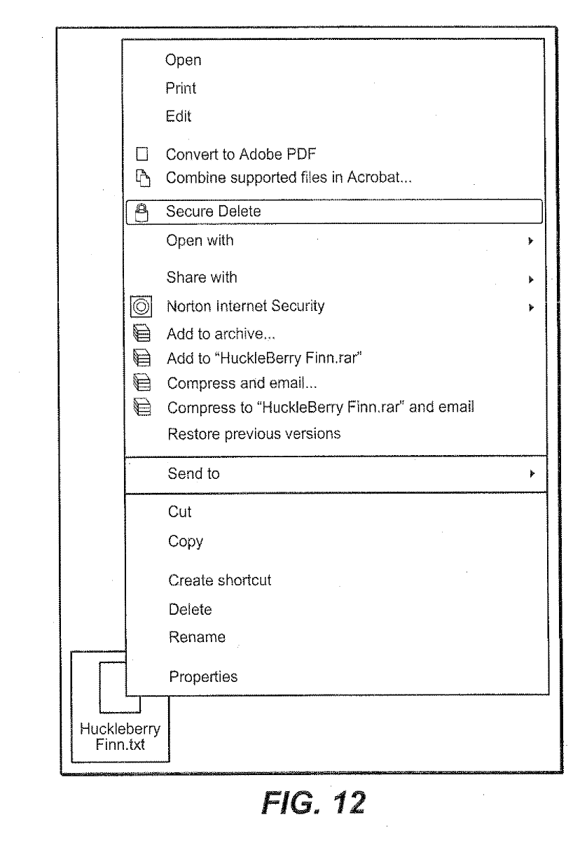

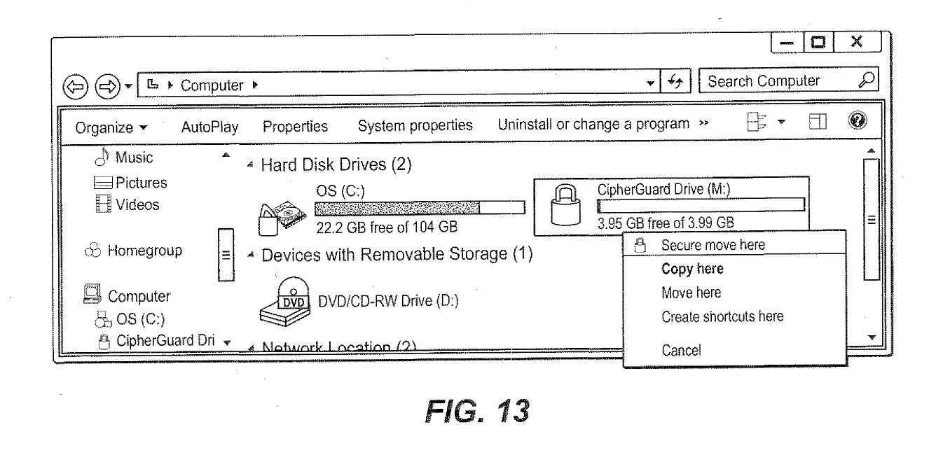

The feature above is illustrated in FIGS. 12 and 13, which are computer screen shots. As shown in FIG. 12, once the device 104 is connected to system 100, in addition to the various options for manipulating data offered by system 100, an additional option “secure delete” is offered to the user. If this option is selected, then the program in medium 102 as executed by controller 114 will request the operating system 116 to delete the data by overwriting it with garbage data, so that there will not be any trace of the original data in system 100 at all, whether in the recycle bin or otherwise. FIG. 13 illustrates the option of “secure move” by which the user may securely move data from an unsecured partition or file into the file-based-drive “CipherGuard Drive.” Once this is done, the original file or data in the unsecured partition or file will be automatically overwritten with garbage data, leaving no trace of it.

### DEK Generation

A DEK is first generated and stored in memory 122 of device 104 in plaintext form. The DEK is stored in a secure partition in device 104, such as memory 122, and not supplied to any entity outside of device 104. The DEK may be stored in Flash memory in a standard way. A skilled attacker can retrieve the saved DEK, but he would not really need to as he already has the key. To protect the DEK in case an attacker obtains possession of the device, passwords may be used to encrypt the DEK as described below, so that confidential and protected data retrieval is not possible without the password. In case the user loses the device 104, then the encrypted data stored in the file-based-drive in system 100 cannot be decrypted and accessed. To enable the user to recover the DEK, in one embodiment, a seed such as a seed value is provided by the user for generating the DEK. This seed value may then be used by the user to regenerate the same DEK value later on. In one implementation of this embodiment, the seed value may be a recovery phrase comprising a string of characters and numbers. The DEK may be generated from this phrase by a known encryption algorithm stored in memory 122 and sent to engine 120 for generating the DEK, so that the same DEK may be generated in the future using the same recovery phrase and the same encryption algorithm. As long as the user still knows or has access to the recovery phrase, the DEK can be regenerated and used to recover the encrypted data.

The recovery phrase may also be used for generating duplicate key devices. This feature is illustrated in FIG. 15, which is a computer screen shot. System 100 queries the user as to whether a duplicate key device or a new key device is desired. If the user selects to make a duplicate key device, the user will be asked to input the recovery phrase to create a duplicate key device. The recovery phrase is passed from system 100 to a new key device of the type shown in FIG. 2 to generate the same DEK as the original key device and stored in the new key device, so that the new key device becomes a duplicate key device to the original key device.

Where the user desires to make a new key device using a DEK that is different from other key devices, the user is asked to input a new passphrase to generate the DEK.

When the user prefers to generate a DEK stored in the key device that cannot be recovered when the device is lost, this indication is collected by the installer 152 in block 202, and passed to device 104. Manager 132 in controller or CPU 124 then causes the random number generator 103 in FIG. 2 to generate a random number. The manager 132 then sends this number to engine 120 for generating a DEK which is then stored in memory 122.

### Master and Slave Keys

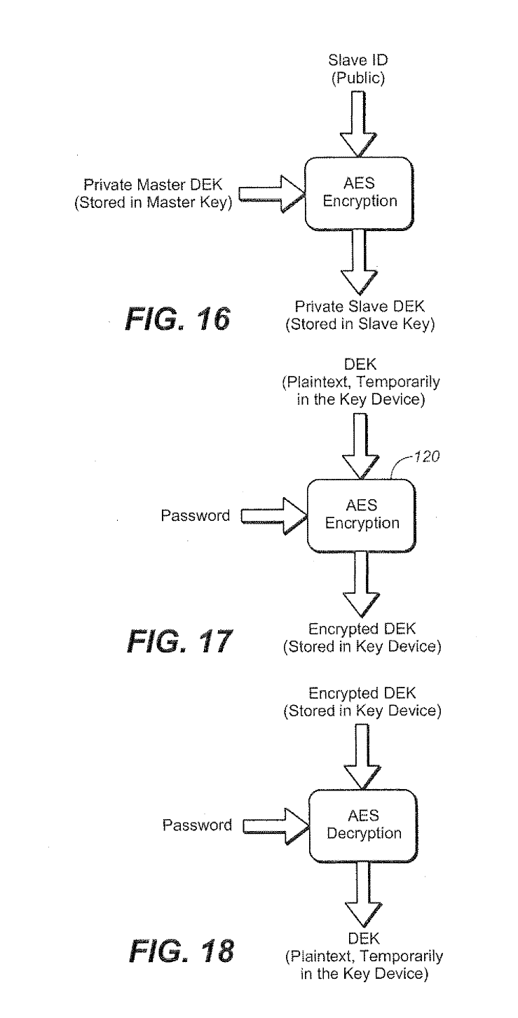

The master key has a secret DEK. This is stored in the master key's hardware in device 104. Each slave key device has a slave ID. This slave ID is public, and is actually part of the filename used for the filed-based-drive. The slave DEK (kept in the slave key device's hardware), is generated by engine 120 under the control of manager 132 in CPU 124, by encrypting the public slave ID with the secret master DEK as illustrated in FIG. 16. Thus, the master key can be used to generate the DEKs of all of the slave key devices, using the secret DEK stored in the master key's hardware. For the master key to recreate the slave DEK, it only needs the slave ID (which is public). Once the Master key has the slave DEK, it can duplicate a slave key or read data protected by the slave key. Having the slave ID by itself is no good without the master DEK.

### Password Protection

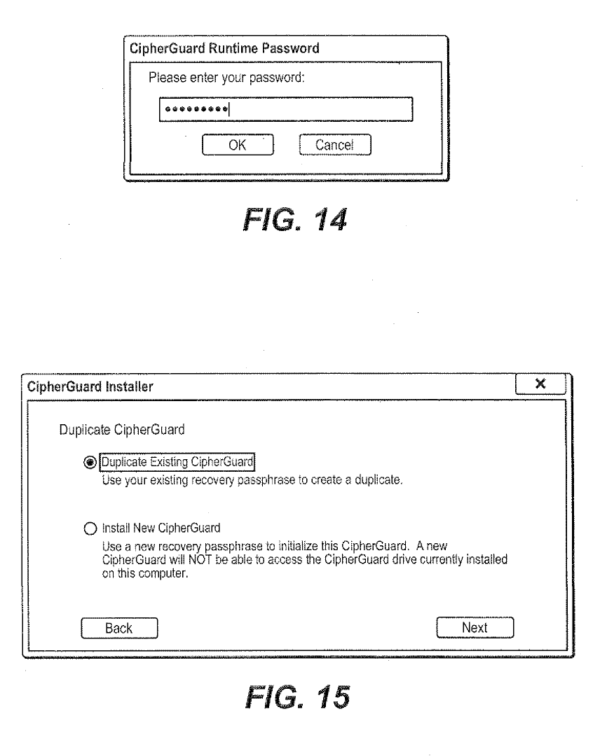

In the above data protection scheme, no password is used at all. For some users accustomed to the use of passwords, system 100 and device 104 may be configured to allow the use of passwords for encrypting the DEK. This is illustrated in FIG. 14, which is a computer screen shot. As shown in FIG. 14, the user is asked by system 100 to input a password, which is then used by system 100 and device 104 for encrypting the DEK.

Normally, the DEK is stored in the key device 104 in plaintext. Where it is desirable to encrypt the DEK, the DEK generated is only temporarily stored in memory 122 of device 104 in plaintext form. When password protection is enabled, an encrypted version of the DEK using the password is stored in the key device 104 instead. This means that the DEK is protected even if an attacker gets hold of the key device. The encryption and decryption of the DEK is illustrated in the schematic diagrams of FIGS. 15 and 16.

As shown in FIG. 15, the password is used in the engine 120 of FIGS. 2 and 15 to encrypt a plaintext DEK stored in memory 122 in device 104, to produce an encrypted DEK which is also stored in memory 122 of device 104, overwriting the plaintext DEK. Thus, the system 100 passes the password inputted by the user to device 104 through interface 118 and to manager 132. Manager (inside the device 104) 132 fetches the plaintext DEK stored in memory 122, and sends both the plaintext DEK and password to engine 120, which performs AES encryption of the DEK using the password under the control of manager 132. The encrypted DEK is then stored in memory, overwriting the plaintext DEK 122.

When it is desirable to access the DEK value for cryptographic processes, the user will need to again input the correct password to system 100. System 100 passes the password inputted by the user to device 104 through interface 118 and to manager 132. Manager 132 fetches the encrypted DEK stored in memory 122, and sends both the encrypted DEK and password to engine 120, which performs AES decryption of the DEK using the password under the control of manager 132 to obtain the plaintext DEK, as illustrated in FIG. 16. The plaintext DEK is then temporarily used in cryptographic processes, after which the plaintext DEK is discarded and not stored.

The embodiments of this invention secure the private data on a computer with a physical key. When the key is inserted in a computer, an encrypted partition appears that the user can access like any other drive. Accesses to this partition are automatically encrypted and decrypted in the background by the key itself The encrypted partition can be used to store applications as well as data. Without the key, the encrypted partition remains in the computer, but does not appear to the user.

Like a physical key, the embodiments of this invention do not require passwords (though they can also be used). Like a physical key, duplicate and master override keys can be created. Like a physical key, the lock mechanism can be changed if the key is lost.

The invention prevents these types of attack (and others) by sequestering not only the encryption key, but also the logic that uses the key (the encryption and decryption logic) in a separate, secure hardware module (the ‘Device’). Access is controlled by the Device to prevent attackers from learning the secret key.

Storing encrypted data on the computer's hard drive has the following advantages:

1. The protected data is recoverable should the user lose or break the key device.

2. The amount of encrypted storage space is only limited by the space on the user's computer. Encrypted partitions can be expanded or added at any time without additional expense.

3. Backups are encrypted.

Having an external device perform the cryptographic functions has the following advantages:

1. The encryption key is hidden from the computer itself. This protects it from hackers, key-loggers, spyware, malware, and other attacks on the computer.

2. The external device acts like a key. It can be inserted or removed at anytime. There is no password or fingerprint logon required. When removed, the encrypted partition just disappears from the computer. This allows other people to use the computer without being able to read the encrypted data.

Not relying on passwords has the following advantages:

1. The user doesn't have to remember another password. There is nothing to write down or forget.

2. As a physical device, the user knows if it is lost. With passwords, the user's private data may have already been compromised without his knowledge.

3. As physical devices, the embodiments of this invention are not vulnerable to key-loggers, hackers, etc.

4. Users are familiar with the key and lock usage model

The embodiments of this invention also combine the following features:

1. Optional password protection for users not comfortable with the device-only us-age model

2. Secure Move, Secure Cut and Paste, and Secure Delete to remove traces the unencrypted file from the computer.

3. Secure disposal—once the recovery pass-phrase is changed in the key device, the encrypted data is no longer accessible. This is a 30 second process.

4. The embodiments of this invention can change the encryption used to protect data. This is similar to changing the locks when a physical key is lost.

5. The embodiments of this invention allow for easy duplication of keys. This is for lost mitigation as well as allowing members of the same team access the same encrypted files.

6. The embodiments of this invention allow for the creation of a master key. Users can have their own keys access their own data. Their manager can have a master key that over-rides the encryption on the individual keys.

7. The embodiments of this invention can monitor for periods of inactivity. If it encounters a pre-defined inactivity interval, it can request the user for a password.

8. The embodiments of this invention can be used to encrypt individual files and folders. This is useful for sharing files over email with someone holding a duplicate key or for individual file back ups.

9. The installation takes less than a minute. Many encryption tools take hours to install.

While the invention has been described above by reference to various embodiments, it will be understood that changes and modifications may be made without departing from the scope of the invention, which is to be defined only by the appended claims and their equivalents.

What is claimed is:

1. A device for cryptographic process comprising:
a cipher engine that encrypts or decrypts data from a host;
a storage for storing cipher keys used in encryption and/or decryption of the data from the host, wherein said device does not store the data that is encrypted or decrypted by the cipher engine; and
a controller that manages interactions of the cipher engine and the storage with the host.

2. The device of claim 1, wherein said controller uses a seed designated by the host for generating a cipher key

3. The device of claim 1, further comprising a random number generator, wherein said controller causes the engine to generate a cipher key using a number generated by said random number generator.

4. The device of claim 1, wherein said controller causes the engine to generate a slave cipher key using a public slave identifier and a hidden master cipher key stored in the storage.

5. The device of claim 1, wherein said controller controls the encryption and decryption of the data from the host by said cipher engine, wherein said controller does not store the data that is encrypted or decrypted by the cipher engine.

6. The device of claim 1, said host having an operating system, said device further comprising a storage medium storing a computer program for creating in the host a file in the host that behaves like a disk drive to the operating system of the host, and for translating accesses to this file by the host into commands, wherein the cipher engine performs encryption and/or decryption of data to/from such file and/or to be stored into such file in response to the commands.

7. The device of claim 1, said host having an operating system, said device further comprising a storage medium storing information useful to a user for obtaining and using a computer program for creating in the host a file that behaves like a disk drive to the operating system of the host, and for translating accesses to this file by the host into commands, wherein the cipher engine performs encryption and/or decryption of data from such file and/or to be stored into such file in response to the commands.

8. The device of claim 1, wherein said controller controls data access with a password by using the password to encrypt and/or decrypt a cipher key in the storage, and sends the decrypted cipher key to the cipher engine for encrypting and/or decrypting data from the host.

9. The device of claim 1, wherein said controller manages interactions of the cipher engine and the storage with the host as soon as the device is connected to the host without the host having to re-boot.

10. The device of claim 9, wherein said device complies with the USB protocol.

11. A host computing system having a memory and an operating system, said computing system running a computer program to create in the system a file that behaves like a disk drive to the operating system of the system for storing encrypted information sent to it by a key device that is connected to the system and that performs cryptographic processes, and to translate accesses to this file by the system into commands, wherein when a command to read or write is issued by the system to the file, the computer program when executed by the system will cause a cipher engine in the key device to perform encryption and/or decryption of data from such file and/or to be stored into such file.

12. The computing system of claim 11, wherein the file is accessible by a user only when the key device is connected to the system.

13. The computing system of claim 11, further comprising a display, wherein the file is visible on a display of the system only when the key device is connected to the system.

14. The computing system of claim 11, said wherein the computer program when executed by the system causes traces of data in the memory that are obsolete as a result of data deletion or data relocation in the memory to be overwritten after such deletion and/or relocation.

15. The computing system of claim 11, wherein the computer program when executed by the system creates a file name and path way in a directory in the system accessible by the operating system of the system, and a driver in the system that accesses data in the file using said file name and path way.

16. The computing system of claim 11, wherein the computer program includes a driver that translates a logical block address from the operating system into a file offset in the file for accessing data in the file.

17. The computing system of claim 11, wherein the computer program includes a driver that transmits to the key device commands that control encrypt and decrypt processes in the key device.

18. A method for cryptographic process comprising:
supplying a key device including a cipher engine that encrypts or decrypts data from a host; and
a storage for storing cipher keys used in encryption and/or decryption of the data from the host, wherein said device does not store the data that is encrypted or decrypted by the cipher engine; and
supplying a storage medium storing a computer program for creating in the host a file that behaves like a disk drive to an operating system of the host, and for translating accesses to this file by the host into commands, wherein the cipher engine performs encryption and/or decryption of data from such file and/or to be stored into such file in response to the commands.

19. A method for cryptographic process comprising:
supplying a key device including a cipher engine that encrypts or decrypts data from a host; and
a storage for storing cipher keys used in encryption and/or decryption of the data from the host, wherein said device does not store the data that is encrypted or decrypted by the cipher engine; and
supplying information for obtaining a computer program for creating in the host a file that behaves like a disk drive to an operating system of the host, and for translating accesses to this file by the host into commands, wherein the cipher engine performs encryption and/or decryption of data from such file and/or to be stored into such file in response to the commands.

20. A computer readable storage medium storing a computer program for use in a computing system having a memory and an operating system, wherein when the computer program is executed by the computing system, a file that behaves like a disk drive to the operating system of the system is created in the memory of the system for storing encrypted information sent to it by a key device that is connected to the system and that performs cryptographic processes, and accesses to this file by the system are translated into commands, wherein when a command to read or write is issued by the system to the file, the computer program when executed by the system will cause a cipher engine in the key device to perform encryption and/or decryption of data from such file and/or to be stored into such file.

21. The storage medium of claim 20, wherein the file is accessible by a user only when the key device is connected to the system.

22. The storage medium of claim 20, wherein the computer program when executed by the system causes traces of data in the memory that are obsolete as a result of data deletion or data relocation in the memory to be overwritten after such deletion and/or relocation.

23. The storage medium of claim 20, wherein the computer program when executed by the system creates a file name and path way in a directory in the system accessible by the operating system of the system, and a driver in the system that accesses data in the file using said file name and path way.

24. The storage medium of claim 20, wherein the computer program includes a driver that translates a logical block address from the operating system of the host into a file offset in the file for accessing data in the file.

25. The storage medium of claim 20, wherein the computer program includes a driver that issues commands that control encrypt and decrypt processes in the key device.
